(19) United States
(12) Patent Application Publication
(10) Pub. No.: US 2026/0071568 A1
(43) Pub. Date: Mar. 12, 2026

(54) SYSTEM AND METHOD FOR CONTROLLING COOLANT OF VEHICLE

(71) Applicants: Hyundai Motor Company, Seoul (KR); Kia Corporation, Seoul (KR)

(72) Inventors: Kyung-Keun Suh, Hwaseong-si (KR); Sun-Gyu Park, Hwaseong-si (KR); Han-Sang Kim, Hwaseong-si (KR); Hyun-Woo Cho, Hwaseong-si (KR); Jong-Gil Kim, Hwaseong-si (KR); Hyeong-Seok Lee, Hwaseong-si (KR)

(21) Appl. No.: 19/250,991

(22) Filed: Jun. 26, 2025

(30) Foreign Application Priority Data
Sep. 10, 2024 (KR) 10-2024-0123326

(51) Int. Cl. F01N 5/02; F01N 3/04; F01N 9/00

(52) U.S. Cl. CPC F01N 5/02; F01N 3/04; F01N 9/00

(57) ABSTRACT

A system for controlling coolant of a vehicle can include an integrated flow control valve configured to open and close branch lines for supplying coolant discharged from an engine of the vehicle to an automatic transmission fluid (ATF) warmer, a heater, and a radiator, respectively, an exhaust heat recovery system configured to exchange heat between exhaust gas discharged from the engine and the coolant discharged from the engine, and a controller configured to control the integrated flow control valve to open and close the branch lines to supply coolant to the ATF warmer, heater, and radiator, respectively, depending on the temperature of the outside air, the coolant temperature discharged from the engine, and the coolant temperature discharged from the exhaust heat recovery system, and control the exhaust heat recovery system to allow heat exchange between the exhaust gas and the coolant.

### CROSS-REFERENCE TO RELATED APPLICATIONS

This application claims priority to Korean Patent Application No. 10-2024-0123326, filed on Sep. 10, 2024, which is incorporated herein by reference in its entirety.

### TECHNICAL FIELD

The present disclosure relates to a system and method for controlling coolant of a vehicle.

### BACKGROUND

Because the exhaust gas emitted from an engine after combustion contains thermal energy, an exhaust heat recovery system (EHRS) is applied to an exhaust pipe to utilize this energy to accelerate the engine's warming-up or for use in cabin heating. The exhaust heat recovery system is configured such that the coolant and exhaust gas can exchange heat, allowing the coolant to absorb heat from the exhaust gas and heat the coolant.

In a case of a hybrid vehicle that uses both an engine and a motor as power sources, the vehicle is driven using the motor during the initial start-up phase of the vehicle, but as the vehicle's speed increases, the engine is engaged to drive the vehicle. As the engine starts driving during the vehicle's operation, the coolant heated by the exhaust heat recovery system is supplied to the engine to quickly warm up the engine, enabling the engine to quickly reach a warmed-up state. Meanwhile, the coolant is supplied from the exhaust heat recovery system to a heater, where it is used for the vehicle's heating.

Because high-temperature exhaust gas passes through the exhaust heat recovery system, the coolant needs to always flow inside the exhaust heat recovery system.

However, when a flow stop function is performed by an integrated flow control valve (ITM; Integrated Thermal Management) provided in the vehicle, causing the flow of coolant to stop until the engine is warmed up, the coolant does not circulate in the exhaust heat recovery system. As a result, the exhaust heat recovery system is not cooled, leading to the occurrence of boiling phenomenon in the exhaust heat recovery system. Accordingly, due to the increase in internal pressure of the exhaust heat recovery system, there was a problem where the vulnerable parts of the exhaust heat recovery system were damaged.

To avoid this, when flow is stopped, a bypass valve of the exhaust heat recovery system should be opened to bypass the exhaust gas, allowing it to discharge directly without exchanging heat with the coolant.

However, the exhaust heat recovery system has a structure in which the bypass valve is opened by wax that expands according to the temperature of the coolant entering the exhaust heat recovery system, so a controller could not operate the exhaust heat recovery system at the desired time. Even if boiling phenomenon occurs inside the exhaust heat recovery system, the bypass valve of the exhaust heat recovery system will not open when there is no flow at an inlet port of the exhaust heat recovery system or when the temperature of the coolant filled inside the inlet port is low. As a result, continuous heat transfer occurs from the exhaust gas to the coolant inside the exhaust heat recovery system, leading to damage of the vulnerable parts of the exhaust heat recovery system.

### SUMMARY

The present disclosure relates to a system and method for controlling coolant of a vehicle, which can allow the flow of coolant to be controlled in an integrated manner by an integrated flow control valve, which can control the flow of vehicle's coolant, based on the temperature of the outside air and coolant temperature, along with an exhaust heat recovery system, which can recover heat from exhaust gases to heat the engine coolant.

Accordingly, an embodiment of the present disclosure considering the above point can provide a system and method for controlling coolant of a vehicle that can prevent boiling damage in the exhaust heat recovery system while quickly warming up a powertrain, including an engine, and can improve the vehicle's fuel efficiency by allowing coolant to selectively pass through an automatic transmission fluid (ATF) warmer and a heater based on the temperature of the outside air and temperature of the coolant, and then to pass through an exhaust heat recovery system.

To achieve the aforementioned advantages, a system for controlling coolant of a vehicle according to an embodiment of the present disclosure may include: an integrated flow control valve configured to open and close branch lines to supply coolant discharged from an engine of a vehicle to an ATF warmer, a heater, and a radiator, respectively; an exhaust heat recovery system configured to exchange heat between exhaust gas discharged from the engine and the coolant discharged from the engine; a main water pump configured to circulate the coolant; and a controller configured to control the integrated flow control valve to open and close the branch lines to supply coolant from the integrated flow control valve to the ATF warmer, the heater, and the radiator, respectively, depending on a temperature of the outside air, a coolant temperature discharged from the engine, and a coolant temperature discharged from the exhaust heat recovery system, and control the exhaust heat recovery system to allow heat exchange between the exhaust gas and the coolant, in which return lines may be provided to circulate the coolant from the exhaust heat recovery system to the ATF warmer and heater, respectively, and the controller may control the circulation of the coolant to either the ATF warmer or the heater from the exhaust heat recovery system based on the temperature of the outside air.

A method of controlling coolant of a vehicle, according to embodiment of the present disclosure, may include: a first outside air temperature comparison step in which a controller compares a temperature of the outside air with a preset reference temperature to identify where to circulate coolant discharged from an engine between an ATF warmer and a heater, and to determine when to stop heat exchange between the coolant and an exhaust heat recovery system; a circulation step in which based on the temperature of the outside air, the controller controls supplying the coolant discharged from the exhaust heat recovery system to either the ATF warmer or the heater; an exhaust heat recovery step in which the controller controls supplying the coolant discharged from the engine to the exhaust heat recovery system; a water temperature comparison step in which the controller identifies whether the temperature of the coolant discharged from the exhaust heat recovery system exceeds a bypass temperature, which is set to allow the coolant to bypass the exhaust heat recovery system; and a bypass step in which when the temperature of the coolant exceeds the bypass temperature, the controller controls allowing exhaust gas to bypass the coolant, causing the exhaust gas to flow through the exhaust heat recovery system, in which in the bypass step, the controller may operate a drive motor of the exhaust heat recovery system to allow the exhaust gas to flow and bypass the coolant through the exhaust heat recovery system.

A method of controlling coolant of a vehicle, according to an embodiment of the present disclosure, may include: a second outside air temperature comparison step in which a controller compares a temperature of the outside air with a preset reference temperature to determine an operating mode of an exhaust heat recovery system and an integrated flow control valve; a mode entry step in which based on the temperature of the outside air, the controller causes the integrated flow control valve to enter a set, selected, or predetermined operating mode; a bypass identification step in which the controller identifies whether exhaust gas passes through the exhaust heat recovery system without exchanging heat with coolant; a flow stop identification step in which the controller identifies whether the integrated flow control valve is controlled in a flow stop state; a flow stop releasing step in which the controller controls releasing a flow stop control of the integrated flow control valve; a water temperature condition comparison step in which the controller identifies whether the temperature of the coolant discharged from the exhaust heat recovery system is below a recovery entry temperature, which is preset to trigger entry into exhaust heat recovery control in the exhaust heat recovery system, while the temperature of the coolant discharged from the exhaust heat recovery system exceeds the temperature of the coolant discharged from an engine; and an exhaust heat recovery entry step in which the controller controls the exhaust heat recovery system to recover exhaust heat.

According to an embodiment of the present disclosure, in a system and method for controlling coolant of a vehicle, such as having one of the configurations described above, the warm-up of the powertrain, including the engine and transmission, can be rapidly performed.

In this manner, because the warm-up of the powertrain can be accelerated, the fuel efficiency of the vehicle can be improved. Due to the reduction in warm-up time, the exhaust performance can be improved, which can result in a decrease in the discharge of harmful substances.

Using an embodiment of the present disclosure, because it can be not necessary to install a PTC heater for indoor heating before warm-up in a hybrid vehicle, the cost associated with the installation of the PTC heater can be reduced.

### BRIEF DESCRIPTION OF THE DRAWINGS

FIG. 1 is a schematic view illustrating a coolant control system of a vehicle according to an embodiment of the present disclosure.

FIG. 2A is a schematic view illustrating a state where coolant circulates through an ATF warmer and an exhaust heat recovery system in a system for controlling coolant of a vehicle according to an embodiment of the present disclosure.

FIG. 2B is a schematic view illustrating a state where coolant circulates through an ATF warmer and an exhaust heat recovery system, while the coolant also circulates through an engine and the exhaust heat recovery system in a system for controlling coolant of a vehicle according to an embodiment of the present disclosure.

FIG. 3A is a schematic view illustrating a state where coolant circulates through a heater and an exhaust heat recovery system in a system for controlling coolant of a vehicle according to an embodiment of the present disclosure.

FIG. 3B is a schematic view illustrating a state where coolant circulates through a heater and an exhaust heat recovery system, while the coolant also circulates through an engine and the exhaust heat recovery system in a system for controlling coolant of a vehicle according to an embodiment of the present disclosure.

FIG. 4 is a perspective view illustrating a state where an electronic exhaust heat recovery system applied to a system for controlling coolant of a vehicle is installed in an exhaust pipe, according to an embodiment of the present disclosure.

FIG. 5 is a flowchart illustrating a method of controlling coolant of a vehicle according to an embodiment of the present disclosure.

FIG. 6A and FIG. 6B are flowcharts illustrating a method of controlling coolant of a vehicle according to an embodiment of the present disclosure.

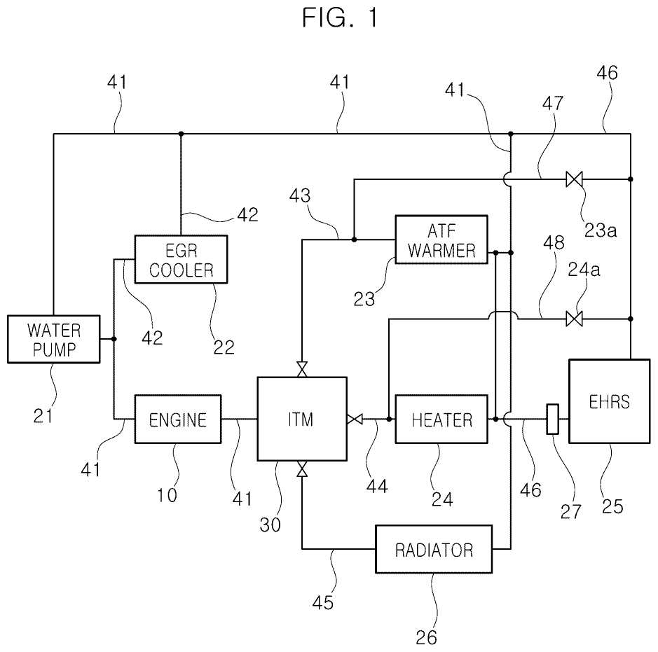

### DETAILED DESCRIPTION OF ILLUSTRATIVE EMBODIMENTS

Hereinafter, example embodiments of the present disclosure will be described in detail with reference to the accompanying drawings, and because these example embodiments, as examples, may be implemented in various different forms by those skilled in the art to which the present disclosure pertains, the present disclosure is not necessarily limited to the example embodiments described herein.

Hereinafter, a system and method of controlling coolant of a vehicle according to an embodiment of the present disclosure will be described in detail with reference to the attached drawings.

A system for controlling coolant of a vehicle according to an embodiment of the present disclosure can include: an integrated flow control valve 30 that can open and close branch lines 43, 44, and 45 for supplying coolant discharged from an engine 10 to an ATF warmer 23, a heater 24, and a radiator 26, respectively; an exhaust heat recovery system 25 that can exchange heat between the exhaust gas discharged from the engine 10 and the coolant discharged from the engine 10; a main water pump 21 that can circulate the coolant; and a controller 50 that can control the integrated flow control valve 30 to open and close the branch lines 43, 44, and 45 to supply coolant to the ATF warmer 23, heater 24, and radiator 26, respectively, depending on the temperature of the outside air, the coolant temperature discharged from the engine 10, and the coolant temperature discharged from the exhaust heat recovery system 25, and also can control the exhaust heat recovery system 25 to allow heat exchange between the exhaust gas and the coolant. Return lines 47 and 48 can be provided to circulate the coolant from the exhaust heat recovery system 25 to the ATF warmer 23 and heater 24, respectively. The controller 50 can control circulating the coolant to either the ATF warmer 23 or the heater 24 from the exhaust heat recovery system 25 based on the temperature of the outside air.

The engine 10 can discharge the exhaust gas generated through combustion to the outside via an exhaust pipe 15. The engine 10 is heated during operation and is cooled through the coolant.

The engine 10 can be equipped with various sensors to detect the engine's condition, and the outputs can be sent to an engine management system (EMS) that controls the engine 10 to control the operation of the engine 10. The sensors also can output sensed values to the controller 50, where the values may be utilized as input values for performing control. For example, the flow of the coolant may be controlled differently depending on the temperature of the coolant discharged from the engine 10.

The vehicle in which the engine 10 is installed can be a hybrid vehicle. The hybrid vehicle can have sections, such as immediately after startup, idle waiting, or downhill driving, where the engine 10 does not operate even after the vehicle is started. In this manner, during the sections where the engine 10 does not operate, the heat from the exhaust gas can be transferred to the engine 10 through the exhaust heat recovery system 25 that will be described below, so that the engine 10 can maintain an appropriate temperature. Therefore, an embodiment of the present disclosure can be particularly well suited for a vehicle that is a hybrid vehicle.

A main water pump 21 can circulate the coolant to ensure that the engine 10 maintains an appropriate temperature. The main water pump 21 can circulate the coolant through a main cooling line 41, thereby cooling the engine 10.

An EGR cooling line 42, branched from the main cooling line 41, can circulate the coolant through the main water pump 21 and an EGR cooler 22, thereby lowering the temperature of the air recirculated to the engine 10 through exhaust gas recirculation (EGR).

The integrated flow control valve 30 (ITM; Integrated Thermal Management) can operate based on the coolant discharged from the engine 10, as controlled by the controller 50 that will be described below, and can determine the flow direction of the coolant. The integrated flow control valve 30 can determine whether the coolant flows, as well as the flow rate, in three directions.

The ATF warmer 23 can have transmission oil flowing inside, and the coolant and the oil can exchange heat. The ATF warmer 23 can be connected to the integrated flow control valve 30 and a first branch line 43, and the first branch line 43 can merge into the main cooling line 41.

The heater 24 can heat the air entering the interior of the vehicle. The heater 24 can heat the air entering the interior of the vehicle by exchanging heat between the air entering the interior of the vehicle and the coolant. The heater 24 can be connected to the integrated flow control valve 30 and a second branch line 44.

The radiator 26 can cool the coolant by exchanging heat between the coolant and the outside air. The radiator 26 can be connected to the integrated flow control valve 30 and a third branch line 45, and the third branch line 45 can merge into the main cooling line 41. As the coolant passes through the radiator 26, it can exchange heat with the outside air supplied by the driving wind or cooling fan, thereby cooling the coolant.

The integrated flow control valve 30 can receive a control signal from the controller 50 that will be described below and can open and close the branch lines 43, 44, and 45, which can supply the coolant discharged from the engine 10 to the ATF warmer 23, heater 24, and radiator 26, respectively. The integrated flow control valve 30 may open and close the first branch line 43 connected to the ATF warmer 23, the second branch line 44 connected to the heater 24, and the third branch line 45 connected to the radiator 26, respectively. The integrated flow control valve 30 can circulate the coolant supplied from the engine 10 to one or more of the ATF warmer 23, the heater 24, or the radiator 26. The integrated flow control valve 30 may be controlled to stop the flow of coolant, preventing the coolant from flowing to any of the ATF warmer 23, the heater 24, or the radiator 26. For example, until the engine 10 is warmed up, the flow may be controlled to stop, preventing the coolant from cooling the engine 10, thereby promoting the warm-up of the engine 10.

The exhaust heat recovery system (EHRS) 25 can be installed in the exhaust pipe 15, and can allow the coolant to flow inside the exhaust heat recovery system 25 to exchange heat with the exhaust gas discharged through the exhaust pipe 15.

The exhaust heat recovery system 25 can be installed on an exhaust heat recovery line 46, which can branch from the heater 24 and merge into the main cooling line 41. The exhaust heat recovery system 25 can receive the coolant discharged from the heater 24, and the coolant discharged from the exhaust heat recovery system 25 can merge into the main cooling line 41. The exhaust heat recovery line 46 may be equipped with an auxiliary water pump 27 to circulate the coolant through the exhaust heat recovery system 25.

The coolant that enters the exhaust heat recovery system 25 through an inlet port 25a can exchange heat with the exhaust gas and then can be discharged through an outlet port 25b. The exhaust heat recovery system 25 can be equipped with a valve inside to control the flow path of the exhaust gas. In the related art, a wax-based actuator filled with wax that expands according to the coolant temperature is provided for the valve. However, in an embodiment of the present disclosure, a drive motor 25c, which can operate based on a control signal from the controller 50, can be provided as an actuator. As an example of a configuration that operates the exhaust heat recovery system by the expansion of wax, various examples have been disclosed in the patent applications filed by the present applicant, including Korean Patent Publication No. 10-2022-0059071 and Korean Patent Publication No. 10-2022-0006896. An embodiment of the present disclosure can replace the actuator in such an exhaust heat recovery system from the wax-based actuator to the drive motor 25c. Because the exhaust heat recovery system 25 may be controlled to operate at the desired time by the control signal, the boiling phenomenon in the exhaust heat recovery system may be prevented using an embodiment of the present disclosure.

A water temperature sensor 25d can be installed at the outlet port 25b to measure the temperature of the coolant discharged from the exhaust heat recovery system 25 and output the measured temperature to the controller 50.

Because the exhaust heat recovery system 25 can operate electronically based on the control signal from the controller 50, the exhaust heat recovery system 25 may be controlled under various conditions. The controller 50 can operate under the control of the vehicle's engine management system (EMS), allowing the exhaust heat recovery system 25 to be easily controlled according to the vehicle's state.

The exhaust heat recovery system 25 and the integrated flow control valve 30 may be controlled in conjunction with each other for combined operation.

An embodiment of the present disclosure can ensure that a closed loop is formed in which the coolant can circulate from the exhaust heat recovery system 25 to the ATF warmer 23 and the heater 24, respectively.

That is, a first return line 47 can be provided for returning the coolant from the exhaust heat recovery system 25 to the ATF warmer 23, and a first opening and closing valve 23a, which can open and close the first return line 47, can be provided on the first return line 47.

A second return line 48 can be provided for returning the coolant from the exhaust heat recovery system 25 to the heater 24, and a second opening and closing valve 24a, which can open and close the second return line 48, can be provided on the second return line 48. The auxiliary water pump 27 can be operated between the heater 24 and the exhaust heat recovery system 25 to supply the coolant to the exhaust heat recovery system 25.

The controller 50 can control the operation of the exhaust heat recovery system 25, the integrated flow control valve, the first opening and closing valve 23a, the second opening and closing valve 24a, the main water pump 21, and the auxiliary water pump 27 according to a set, selected, or predetermined logic. That is, the controller 50 can control the integrated flow control valve 30 to open and close the first branch line 43, the second branch line 44, and the third branch line 45, which can supply coolant from the integrated flow control valve 30 to the ATF warmer 23, the heater 24, and the radiator 26, respectively, based on the temperature of the outside air, the coolant temperature discharged from the engine 10, and the coolant temperature discharged from the exhaust heat recovery system 25. The controller 50 also can control the exhaust heat recovery system 25 to enable heat exchange between the exhaust gas and the coolant.

The controller 50 can store a method of controlling coolant of a vehicle, which will be described below, as a logic, and control the coolant to flow according to the conditions.

A detailed description of the controller 50 is omitted.

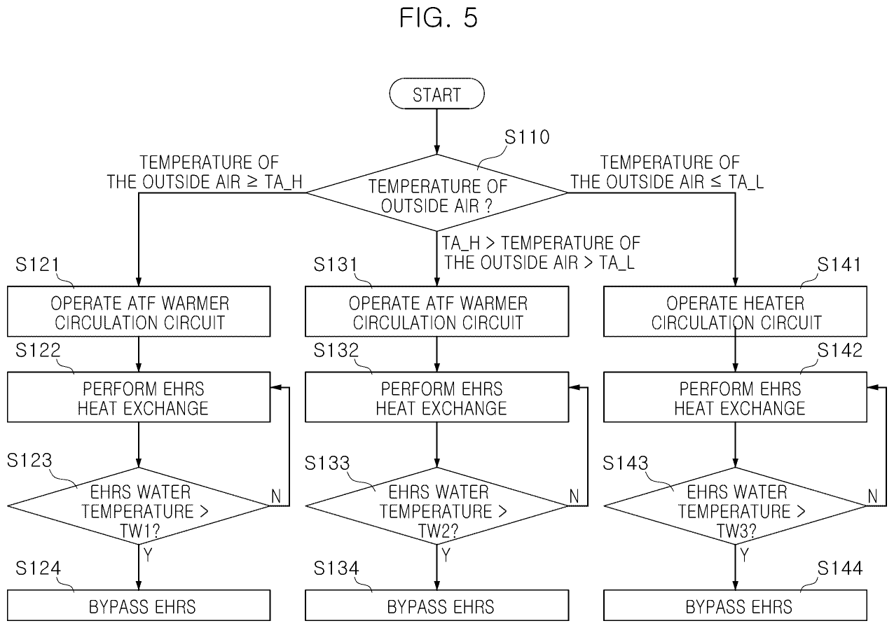

Referring to the flowchart of FIG. 5, a method of controlling coolant of a vehicle according to an embodiment of the present disclosure can include: a first outside air temperature comparison step (S110) in which the controller 50 can compare the temperature of the outside air with preset reference temperatures (TA_H) and (TA_L) to identify where to circulate coolant discharged from the engine 10 between the ATF warmer 23 and the heater 24, and to determine when to stop heat exchange between the coolant and the exhaust heat recovery system 25; a circulation step (S121)(S131)(S141) in which based on the temperature of the outside air, the controller 50 can control supplying the coolant discharged from the exhaust heat recovery system 25 to either the ATF warmer 23 or the heater 24; an exhaust heat recovery step (S122)(S132)(S142) in which the controller 50 can control supplying the coolant discharged from the engine 10 to the exhaust heat recovery system 25; a water temperature comparison step (S123)(S133)(S143) in which the controller 50 can identify whether the temperature of the coolant discharged from the exhaust heat recovery system 25 exceeds a bypass temperature (TW1), (TW2), or (TW3), which can be set to allow the coolant to bypass the exhaust heat recovery system 25; and a bypass step (S124)(S134) (S144) in which when the temperature of the coolant exceeds the bypass temperature (TW1), (TW2), or (TW3), the controller 50 can allow exhaust gas to bypass the coolant, causing the exhaust gas to flow through the exhaust heat recovery system 25. In the bypass step (S124)(S134)(S144), the controller 50 can operate the drive motor 25c of the exhaust heat recovery system 25 to allow the exhaust gas to flow and bypass the coolant through the exhaust heat recovery system 25.

The method of controlling coolant of a vehicle can be performed by the system for controlling coolant of a vehicle described above.

The controller 50, e.g., based on the logic pre-stored therein, can control circulating the coolant from the exhaust heat recovery system 25 to either the ATF warmer 23 or the heater 24 according to the temperature of the outside air, and cause the heat exchange between the exhaust gas and the coolant to stop.

The first outside air temperature comparison step (S110) can involve the controller 50 comparing the temperature of the outside air with the preset reference temperatures (TA_H) and (TA_L) to identify where to circulate the coolant discharged from the engine 10 between the ATF warmer 23 and the heater 24, and determine when to stop the heat exchange between the coolant and the exhaust heat recovery system 25.

Depending on the temperature of the outside air, the priority for supplying the heated coolant between the ATF warmer 23 and the heater 24 can vary. The first outside air temperature comparison step (S110) can involve identifying where to circulate the coolant discharged from the engine 10 between the ATF warmer 23 and the heater 24. Therefore, in the first outside air temperature comparison step (S110), the temperature of the outside air can be compared with the reference temperatures (TA_H) and (TA_L).

As the temperature of the outside air increases, the temperature of the coolant rises faster, reducing the time it takes to reach the boiling point. Therefore, to prevent overheating of the exhaust heat recovery system 25, the timing to stop the heat exchange between the exhaust gas and the coolant in the exhaust heat recovery system 25 can be determined. In this regard, in the first outside air temperature comparison step (S110), the temperature of the outside air can be compared with the reference temperatures (TA_H) and (TA_L).

In the first outside air temperature comparison step (S110), the controller 50 can identify whether the temperature of the outside air is equal to or higher than a high-temperature reference temperature (TA_H) that can be set or selected to identify the temperature of the outside air as a high temperature, equal to or lower than a low-temperature reference temperature (TA_L) that can be set or selected to identify the temperature of the outside air as a low temperature and be lower than the high-temperature reference temperature (TA_H), or lower than the high-temperature reference temperature (TA_H) and above the low-temperature reference temperature (TA_L) to identify the temperature of the outside air as a room temperature.

As examples, the high-temperature reference temperature (TA_H) may be set to 35° C., and the low-temperature reference temperature (TA_L) may be set to 10° C.

Accordingly, referring to FIG. 5 and considering an example embodiment, when the temperature of the outside air is 35° C. or higher in the first outside air temperature comparison step (S110), steps S121 to S124 are performed, when the temperature of the outside air is below 35° C. but above 10°C., steps S131 to S134 are performed, or when the temperature of the outside air is 10° C. or lower, steps S141 to S144 are performed.

The circulation step (S121)(S131)(S141) can involve the controller 50, based on the temperature of the outside air in the first outside air temperature comparison step (S110), ensuring that the coolant discharged from the exhaust heat recovery system 25 is supplied to either the ATF warmer 23 or the heater 24.

The exhaust heat recovery step (S122)(S132)(S142) can involve the coolant discharged from the engine 10 being supplied to the exhaust heat recovery system 25. The coolant discharged from the engine 10 can pass through the exhaust heat recovery system 25 and then can be supplied back to the engine 10. In this way, as the coolant circulates between the engine 10 and the exhaust heat recovery system 25, it may be used to warm up the engine 10 by utilizing the heat from the exhaust gas.

The water temperature comparison step (S123)(S133)(S143) can involve the controller 50 identifying whether the temperature of the coolant discharged from the exhaust heat recovery system 25 exceeds the bypass temperature (TW1), (TW2), or (TW3), which can be set or selected to cause the cooling water to bypass the exhaust heat recovery system 25.

The bypass temperature (TW1), (TW2), or (TW3) may be set lower as the temperature of the outside air increases.

When the temperature of the outside air is equal to or higher than the high-temperature reference temperature (TA_H), the bypass temperature (TW1), (TW2), or (TW3) can be set to a selected or predetermined high-temperature bypass temperature (TW1), when the temperature of the outside air is equal to or lower than the low-temperature reference temperature (TA_L), the bypass temperature (TW1), (TW2), or (TW3) can be set to a selected or predetermined low-temperature bypass temperature (TW3), and when the temperature of the outside air is below the high-temperature reference temperature (TA_H) and above the low-temperature reference temperature (TA_L), the bypass temperature (TW1), (TW2), or (TW3) can be set to a selected or predetermined room-temperature bypass temperature (TW2).

As the temperature of the outside air increases, the coolant reaches its boiling point more quickly. Therefore, the room-temperature bypass temperature (TW2) can be set higher than the high-temperature bypass temperature (TW1), and the low-temperature bypass temperature (TW3) can be set higher than the room-temperature bypass temperature (TW2).

As examples, the high-temperature bypass temperature (TW1), room-temperature bypass temperature (TW2), and low-temperature bypass temperature (TW3) may be set to 80° C., 90° C., and 100° C., respectively.

The bypass step (S124)(S134)(S144) can involve the controller 50 ensuring that, when the temperature of the coolant exceeds the bypass temperature (TW1), (TW2), or (TW3), the heat exchange between the exhaust gas and the coolant is stopped. In such example case, the controller 50 can cause the exhaust gas to bypass the coolant and flow through the exhaust heat recovery system 25.

In such example case, the controller 50 can operate the drive motor 25c of the exhaust heat recovery system 25, causing the exhaust gas to bypass the coolant and flow through the exhaust heat recovery system 25.

Based on the temperature of the outside air in the first outside air temperature comparison step (S110), the circulation step (S121)(S131)(S141) to the bypass step (S124)(S134)(S144) can be performed as follows.

First, the case where the temperature of the outside air is equal to or higher than the high-temperature reference temperature (TA_H) in the first outside air temperature comparison step (S110) is described below.

If the temperature of the outside air is equal to or higher than the high-temperature reference temperature (TA_H), in the circulation step (S121)(S131) (S141), the first circulation step (S121) can be performed where the controller 50 can cause the coolant to flow to the ATF warmer 23. When the temperature of the outside air is high, there is no heating demand for the vehicle's interior. Therefore, the coolant discharged from the exhaust heat recovery system 25 can be flowed to the ATF warmer 23, enabling the transmission oil to warm up quickly.

In the first circulation step (S121), the controller 50 can control as follow.

The controller 50 can control the coolant not to flow from the engine 10 to the outside. For example, when the integrated flow control valve 30 is provided to control the flow of the coolant discharged from the engine 10, the controller 50 can control the integrated flow control valve 30 to be in a flow stop state. That is, the controller 50 can control the integrated flow control valve 30 to ensure that the coolant does not flow through the first branch line 43, the second branch line 44, and the third branch line 45 from the integrated flow control valve 30 by closing all exits of the integrated flow control valve 30.

The controller 50 can control the drive motor 25c of the exhaust heat recovery system 25 to ensure that the exhaust gas exchanges heat with the coolant and is then discharged from the exhaust heat recovery system 25. That is, after the exhaust gas exchanges heat with the coolant in the exhaust heat recovery system 25, the controller 50 can operate the drive motor 25c to close the bypass valve of the exhaust heat recovery system 25, allowing the exhaust gas to be discharged to the outside. The first opening and closing valve 23a can be opened, and the second opening and closing valve 24a can be closed.

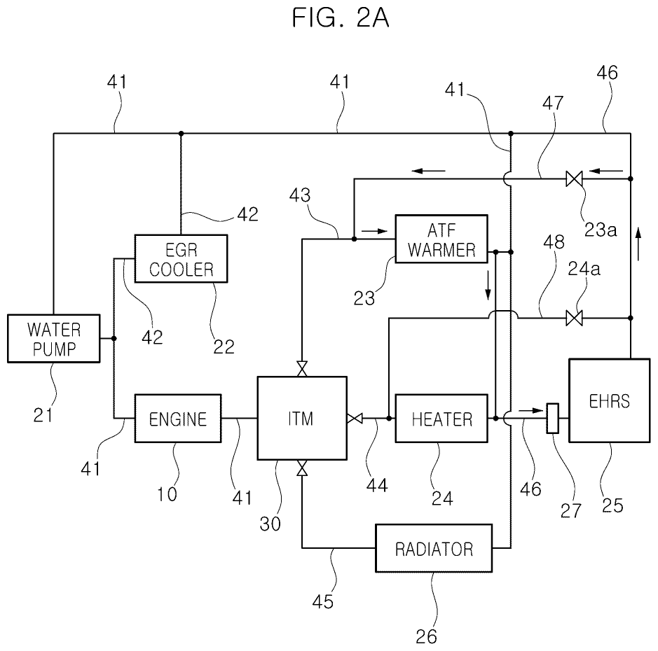

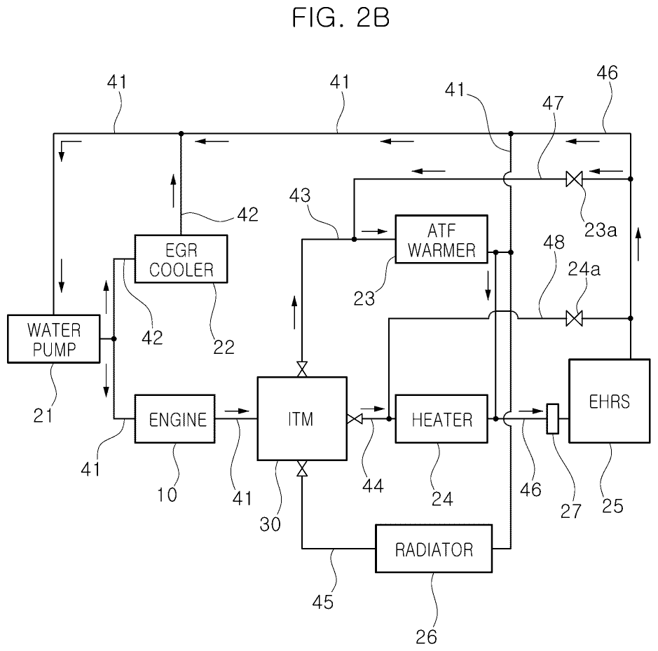

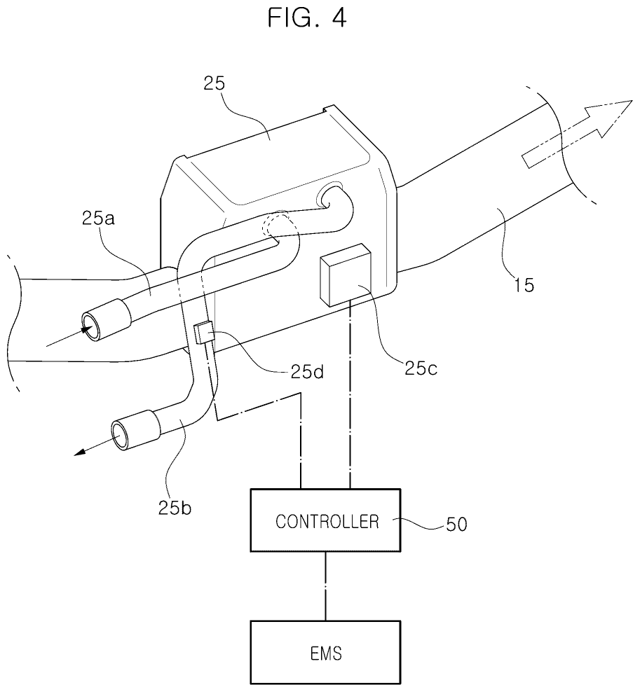

Next, referring to FIGS. 2A to 4, a variety of states during use of a system and methods according to some embodiments of the present disclosure will be described.

Accordingly, as illustrated in FIG. 2A, the coolant circulates through the exhaust heat recovery system 25 and the ATF warmer 23. The coolant, after being heated in the exhaust heat recovery system 25, heats the transmission oil in the ATF warmer 23.

Subsequently, in the exhaust heat recovery step (S122)(S132)(S142), in a state where the temperature of the outside air is high, i.e., equal to or greater than the high-temperature reference temperature (TA_H), the first exhaust heat recovery step (S122) is performed, where the controller 50 causes the coolant discharged from the engine 10 to be introduced into the exhaust heat recovery system 25.

The first exhaust heat recovery step (S122) involves the exhaust gas and the coolant exchanging heat in the exhaust heat recovery system 25, while the coolant discharged from the engine 10 also circulates between the engine 10 and the exhaust heat recovery system 25. As a result, the heat from the exhaust heat recovery system 25 may be absorbed by the engine 10, thereby accelerating the warm-up of the engine 10.

In this case, the controller 50, as in the first circulation step (S121), while controlling the drive motor 25c and the first opening and closing valve 23a, additionally controls the coolant to flow through the engine 10 and the exhaust heat recovery system 25 (see FIG. 2B).

When the integrated flow control valve 30 is provided, the controller 50 may control the integrated flow control valve 30 to allow the coolant to flow from the engine 10 through the ATF warmer 23 to the exhaust heat recovery system 25.

In the water temperature comparison step (S123)(S133)(S143), when the temperature of the outside air is high, a first water temperature comparison step (S123) is performed, where the controller 50 identifies whether the temperature of the coolant discharged from the exhaust heat recovery system 25 exceeds the high-temperature bypass temperature (TW1), which is set to bypass the exhaust heat recovery system 25 in case of high temperature.

When the temperature of the outside air is high, i.e., when the temperature of the outside air is equal to or greater than the high-temperature reference temperature (TA_H) of 35° C., the high-temperature bypass temperature (TW1) may be set to 80° C. Accordingly, the first water temperature comparison step (S123) identifies whether the temperature of the coolant discharged from the exhaust heat recovery system 25 exceeds 80° C.

When the temperature of the coolant exceeds the high-temperature bypass temperature (TW1), the first bypass step (S124) is performed, where the controller 50 operates the drive motor 25c to cause the coolant to bypass the exhaust heat recovery system 25.

In the first bypass step (S124), when the temperature of the outside air is equal to or greater than the high-temperature reference temperature (TA_H) and the temperature of the coolant in the exhaust heat recovery system 25 exceeds the high-temperature bypass temperature (TW1), the controller 50 cause the exhaust gas to bypass the exhaust heat recovery system 25, thereby stopping the heat exchange between the exhaust gas and the coolant within the exhaust heat recovery system 25 to prevent the coolant in the exhaust heat recovery system 25 from reaching its boiling point.

Specifically, in the first bypass step (S124), the controller 50 operates the drive motor 25c to allow the exhaust gas to pass through the exhaust heat recovery system 25 without exchanging heat with the coolant inside the system. When the bypass valve installed inside the exhaust heat recovery system 25 is closed, the exhaust gas passes through after exchanging heat with the coolant. However, when the bypass valve is open, the exhaust gas passes through without exchanging heat with the coolant. In the first bypass step (S124), the controller 50 controls the drive motor 25c to open the bypass valve.

When the temperature of the coolant discharged from the exhaust heat recovery system 25 does not exceed the high-temperature bypass temperature (TW1) in the first water temperature comparison step (S123), the first exhaust heat recovery step (S122) is repeatedly performed.

Second, the case where the temperature of the outside air is below the high-temperature reference temperature (TA_H) but above the low-temperature reference temperature (TA_L) in the first outside air temperature comparison step (S110) is described below.

Even when the temperature of the outside air is below the high-temperature reference temperature (TA_H) but exceeds the low-temperature reference temperature (TA_L), being room temperature, the circulation step (S121) (S131)(S141) to the bypass step (S124)(S134)(S144) are performed in a manner similar to when the temperature of the outside air exceeds the high-temperature reference temperature (TA_H).

That is, when the temperature of the outside air is below the high-temperature reference temperature (TA_H) but exceeds the low-temperature reference temperature (TA_L), the circulation step (S121)(S131)(S141) to the bypass step (S124)(S134)(S144) are performed as a second circulation step (S131), a second exhaust heat recovery step (S132), a second water temperature comparison step (S133), and a second bypass step (S134).

In this case, the second circulation step (S131), the second exhaust heat recovery step (S132), and the second bypass step (S134) are controlled by the controller 50 in a manner similar to the first circulation step (S121), the first exhaust heat recovery step (S122), and the first bypass step (S124). However, in the second water temperature comparison step (S133), the controller 50 sets the reference temperature, i.e., the room-temperature bypass temperature (TW2), differently from the high-temperature bypass temperature (TW1).

When the temperature of the outside air is room temperature, in the circulation step (S121)(S131)(S141), the second circulation step (S131) is performed, where the controller 50 causes the coolant to flow to the ATF warmer 23. Even when the temperature of the outside air is room temperature, there is no heating demand for the vehicle's interior. Therefore, the coolant discharged from the exhaust heat recovery system 25 flows to the ATF warmer 23, heating the transmission oil.

In the second circulation step (S131), the controller 50 controls as follows.

The controller 50 controls the coolant not to flow from the engine 10 to the outside. As in the first circulation step (S121), when the integrated flow control valve 30 is provided, the controller 50 controls the integrated flow control valve 30 to be in a flow stop state, ensuring that all exits of the integrated flow control valve 30 are closed.

Additionally, the controller 50 controls the drive motor 25c of the exhaust heat recovery system 25 to ensure that the exhaust gas exchanges heat with the coolant and is then discharged in the exhaust heat recovery system 25. The controller also opens the first opening and closing valve 23a and closes the second opening and closing valve 24a.

As illustrated in FIG. 2A, the coolant circulates through the exhaust heat recovery system 25 and the ATF warmer 23, heating the transmission oil in the ATF warmer 23.

Subsequently, in the exhaust heat recovery step (S122)(S132)(S142), when the temperature of the outside air is room temperature, the second exhaust heat recovery step (S132) is performed, where the controller 50 cause the coolant discharged from the engine 10 to be introduced into the exhaust heat recovery system 25.

The second exhaust heat recovery step (S132) also involves the exhaust gas and the coolant exchanging heat in the exhaust heat recovery system 25, while the coolant discharged from the engine 10 also circulates between the engine 10 and the exhaust heat recovery system 25.

In this case, the controller 50, as in the first circulation step (S121), while controlling the drive motor 25c and the first opening and closing valve 23a, additionally controls the coolant to flow through the engine 10 and the exhaust heat recovery system 25 (see FIG. 2B).

When the integrated flow control valve 30 is provided, the controller 50 may control the integrated flow control valve 30 to allow the coolant to flow from the engine 10 through the ATF warmer 23 to the exhaust heat recovery system 25.

In the water temperature comparison step (S123)(S133)(S143), when the temperature of the outside air is room temperature, the second water temperature comparison step (S123) is performed, where the controller 50 identifies whether the temperature of the coolant discharged from the exhaust heat recovery system 25 exceeds the room-temperature bypass temperature (TW2), which is set to bypass the exhaust heat recovery system 25 in case of room temperature.

When the temperature of the outside air is room temperature, i.e., when the temperature of the outside air is below the high-temperature reference temperature (TA_H) of 35° C. and exceeds the low-temperature reference temperature (TA_L) of 10° C., the room-temperature bypass temperature (TW2) may be set to 90° C. Accordingly, the second water temperature comparison step (S133) identifies whether the temperature of the coolant discharged from the exhaust heat recovery system 25 exceeds 90° C.

When the temperature of the outside air is room temperature, the coolant takes longer to reach its boiling point compared to when the temperature of the outside air is high. Therefore, the room-temperature bypass temperature (TW2) can be set higher than the high-temperature bypass temperature (TW1).

When the temperature of the coolant exceeds the room-temperature bypass temperature (TW2), the second bypass step (S134) is performed, where the controller 50 operates the drive motor 25c to cause the coolant to bypass the exhaust heat recovery system 25.

In the second bypass step (S134), when the temperature of the outside air is below the high-temperature reference temperature (TA_H) but exceeds the low-temperature reference temperature (TA_L), and the temperature of the coolant in the exhaust heat recovery system 25 exceeds the room-temperature bypass temperature (TW2), the controller 50 causes the exhaust gas to bypass the exhaust heat recovery system 25, thereby stopping the heat exchange between the exhaust gas and the coolant within the exhaust heat recovery system 25 to prevent the coolant in the exhaust heat recovery system 25 from reaching its boiling point.

That is, in the second bypass step (S134), the controller 50 operates the drive motor 25c to allow the exhaust gas to pass through the exhaust heat recovery system 25 without exchanging heat with the coolant inside the exhaust heat recovery system 25. That is, the controller 50 controls the drive motor 25c to open the bypass valve.

Even in the second water temperature comparison step (S133), when the temperature of the coolant discharged from the exhaust heat recovery system 25 does not exceed the room-temperature bypass temperature (TW2), the second exhaust heat recovery step (S132) is repeatedly performed.

Further, the case where the temperature of the outside air is equal to or lower than the low-temperature reference temperature (TA_L) in the first outside air temperature comparison step (S110) is described below.

When the temperature of the outside air is equal to or lower than the low-temperature reference temperature (TA_L), in the circulation step (S121) (S131)(S141), a third circulation step (S141) is performed, where the controller 50 causes the coolant to flow to the heater 24. When the temperature of the outside air is low, there is a heating demand for the vehicle's interior. Therefore, the coolant discharged from the exhaust heat recovery system 25 flows to the heater 24, heating the air supplied to the vehicle's interior and warming up the cabin.

In the third circulation step (S141), the controller 50 controls as follows.

The controller 50 controls the coolant not to flow from the engine 10 to the outside. For example, when the integrated flow control valve 30 is provided to control the flow of the coolant discharged from the engine 10, the controller 50 controls the integrated flow control valve 30 to be in a flow stop state. That is, the controller 50 controls the integrated flow control valve 30 to ensure that the coolant does not flow through the first branch line 43, the second branch line 44, and the third branch line 45 from the integrated flow control valve 30 by closing all exits of the integrated flow control valve 30.

Additionally, the controller 50 controls the drive motor 25c of the exhaust heat recovery system 25 to ensure that the exhaust gas exchanges heat with the coolant and is then discharged from the exhaust heat recovery system 25. The drive motor 25c closes the bypass valve of the exhaust heat recovery system 25, allowing the exhaust gas to exchange heat with the coolant inside the exhaust heat recovery system 25 before being discharged. Additionally, the first opening and closing valve 23a is closed, and the second opening and closing valve 24a is opened.

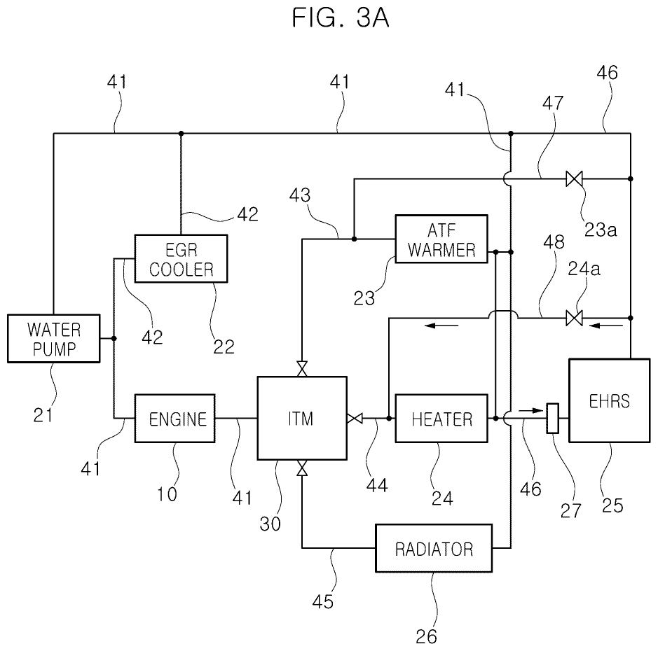

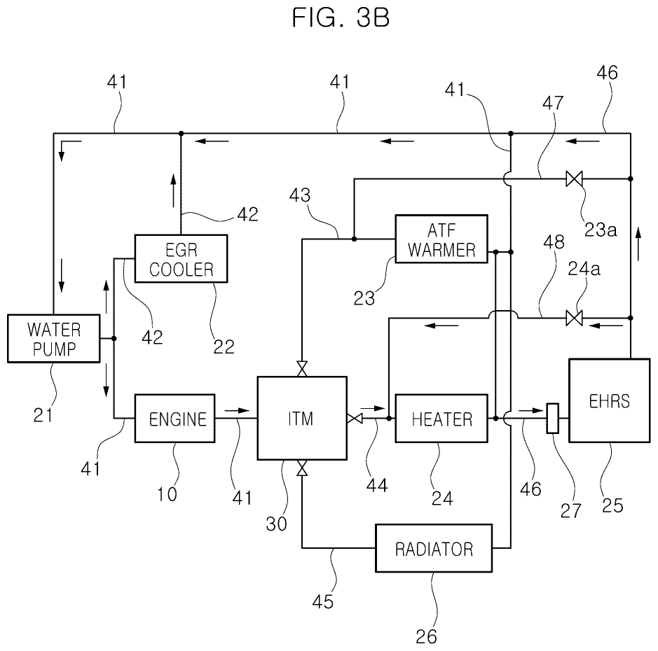

As a result, the coolant circulates through the exhaust heat recovery system 25 and the heater 24, as illustrated in FIG. 3A. The coolant, after being heated in the exhaust heat recovery system 25, passes through the heater 24, heating the air that is introduced into the interior, thereby warming up the cabin of the vehicle.

Subsequently, in the exhaust heat recovery step (S122)(S132)(S142), when the temperature of the outside air is low, the third exhaust heat recovery step (S142) is performed, where the controller 50 cause the coolant discharged from the engine 10 to be introduced into the exhaust heat recovery system 25.

The third exhaust heat recovery step (S142) involves the exhaust gas and the coolant exchanging heat in the exhaust heat recovery system 25, while the coolant discharged from the engine 10 also circulates between the engine 10 and the exhaust heat recovery system 25. As a result, the heat from the exhaust heat recovery system 25 may be absorbed by the engine 10, thereby accelerating the warm-up of the engine 10 in a low-temperature environment.

In this case, the controller 50, as in the third circulation step (S141), while controlling the drive motor 25c and the second opening and closing valve 24a, additionally controls the coolant to flow through the engine 10 and the exhaust heat recovery system 25 (see FIG. 3B).

When the integrated flow control valve 30 is provided, the controller 50 may control the integrated flow control valve 30 to allow the coolant to flow from the engine 10 through the heater 24 to the exhaust heat recovery system 25.

In the water temperature comparison step (S123)(S133)(S143), when the temperature of the outside air is low, the third water temperature comparison step (S143) is performed, where the controller 50 identifies whether the temperature of the coolant discharged from the exhaust heat recovery system 25 exceeds the low-temperature bypass temperature (TW3), which is set to bypass the exhaust heat recovery system 25 in case of low temperature.

When the temperature of the outside air is low, i.e., when the temperature of the outside air is equal to or below the low-temperature reference temperature (TA_L) of 10° C., the low-temperature bypass temperature (TW3) may be set to 100° C. Therefore, the third water temperature comparison step (S143) identifies whether the temperature of the coolant discharged from the exhaust heat recovery system 25 exceeds 100° C.

In particular, when the temperature of the outside air is low, the coolant takes longer to reach its boiling point compared to when the temperature is high or room temperature. Therefore, the low-temperature bypass temperature (TW3) is set higher than the high-temperature bypass temperature (TW1) or the room-temperature bypass temperature (TW2).

When the temperature of the coolant exceeds the low-temperature bypass temperature (TW3), a third bypass step (S144) is performed, where the controller 50 operates the drive motor 25c to cause the coolant to bypass the exhaust heat recovery system 25.

In the third bypass step (S144), when the temperature of the outside air is equal to or greater than the low-temperature reference temperature (TA_L) and the temperature of the coolant in the exhaust heat recovery system 25 exceeds the low-temperature bypass temperature (TW3), the controller 50 cause the exhaust gas to bypass the exhaust heat recovery system 25, thereby stopping the heat exchange between the exhaust gas and the coolant within the exhaust heat recovery system 25 to prevent the coolant in the exhaust heat recovery system 25 from reaching its boiling point.

That is, in the third bypass step (S144), the controller 50 operates the drive motor 25c to allow the exhaust gas to pass through the exhaust heat recovery system 25 without exchanging heat with the coolant inside the system. The controller 50 controls the drive motor 25c to open the bypass valve installed inside the exhaust heat recovery system 25.

In the third water temperature comparison step (S143), when the temperature of the coolant discharged from the exhaust heat recovery system 25 does not exceed the low-temperature bypass temperature (TW3), the third exhaust heat recovery step (S142) is repeatedly performed.

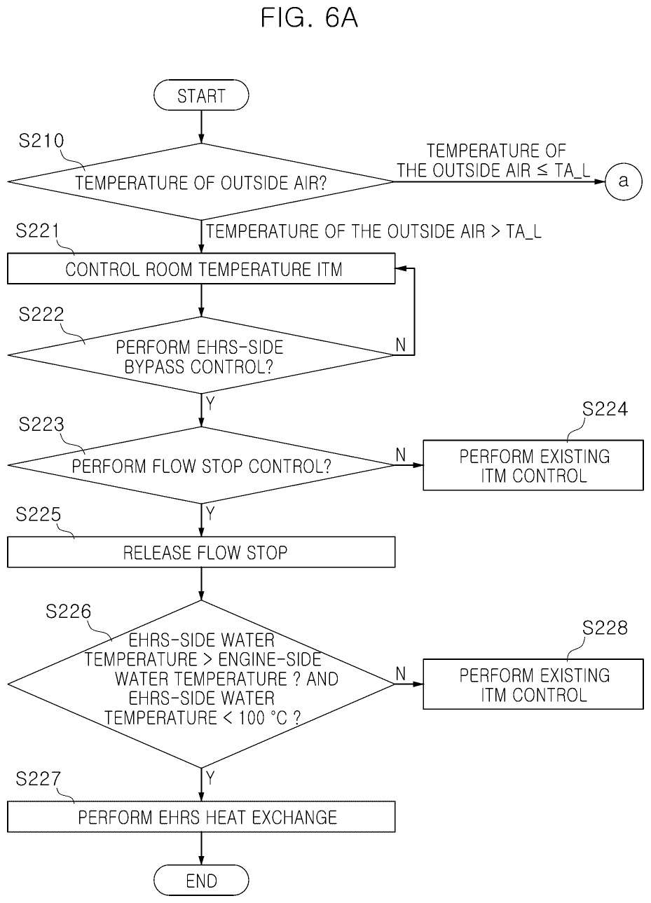

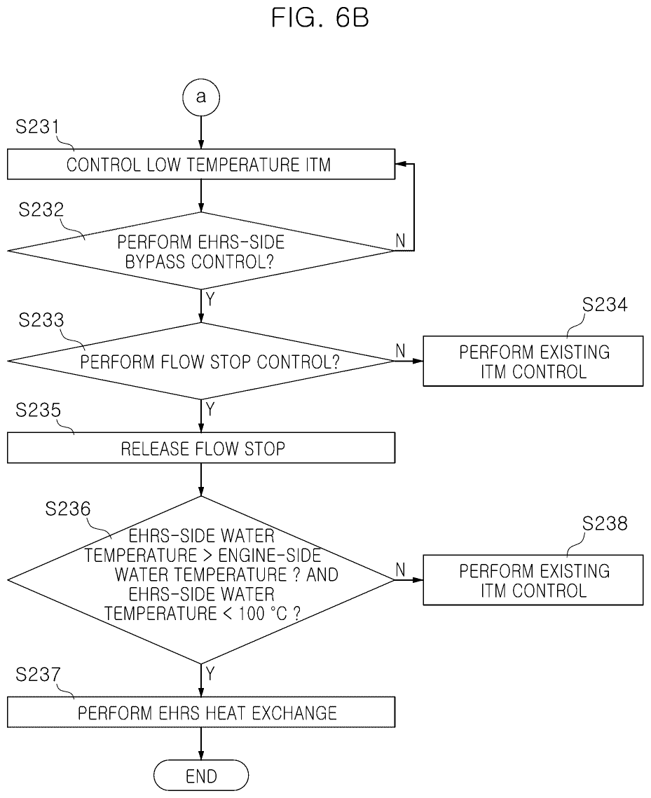

FIGS. 6A and 6B illustrate a method of controlling coolant of a vehicle according to an embodiment of the present disclosure.

Referring to FIGS. 6A and 6B, a method of controlling coolant of a vehicle according to this example embodiment can include: a second outside air temperature comparison step (S210) in which the controller 50 can compare the temperature of the outside air with a selected or preset reference temperature (TA_L) to determine an operating mode of the exhaust heat recovery system 25 and the integrated flow control valve 30; a mode entry step (S221)(S231) in which based on the temperature of the outside air, the controller 50 can cause the integrated flow control valve 30 to enter a set, selected, or predetermined operating mode; a bypass identification step (S222)(S232) in which the controller 50 can identify whether the exhaust gas passes through the exhaust heat recovery system 25 without exchanging heat with the coolant; a flow stop identification step (S223)(S233) in which the controller 50 can identify whether the integrated flow control valve 30 is controlled in a flow stop state; a flow stop releasing step (S225) (S235) in which the controller 50 can release a flow stop control of the integrated flow control valve 30; a water temperature condition comparison step (S226) (S236) in which the controller 50 can identify whether the temperature of the coolant discharged from the exhaust heat recovery system 25 is below a recovery entry temperature, which can be preset to trigger entry into exhaust heat recovery control in the exhaust heat recovery system 25, while the temperature of the coolant discharged from the exhaust heat recovery system 25 exceeds the temperature of the coolant discharged from the engine 10; and an exhaust heat recovery entry step (S227)(S237) in which the controller 50 can control the exhaust heat recovery system 25 to recover exhaust heat.

The second outside air temperature comparison step (S210) can involve the controller 50 comparing the temperature of the outside air with a preset reference temperature (TA_L) to determine the operating mode of the exhaust heat recovery system 25 and the integrated flow control valve 30.

Even in this example embodiment, because the control of the exhaust heat recovery system 25 and the integrated flow control valve 30 can vary depending on the temperature of the outside air, the temperature of the outside air can be first compared with the reference temperature (TA_L).

The mode entry step (S221)(S231) can involve the controller 50, based on the temperature of the outside air, causing the integrated flow control valve 30 to enter a selected or predetermined operating mode.

The bypass identification step (S222)(S232) can involve the controller 50 identifying whether the exhaust gas passes through the exhaust heat recovery system 25 without exchanging heat with the coolant. The exhaust heat recovery system 25 can have a structure that allows heat exchange between the exhaust gas and the coolant, enabling the heat from the exhaust gas to be transferred to the coolant. However, depending on the vehicle's operating conditions, the exhaust gas may bypass the coolant and be directly discharged without heat exchange with the coolant. In the bypass identification step (S222)(S232), the controller 50 can identify whether the exhaust heat recovery system 25 is in a bypass state.

The flow stop identification step (S223)(S233) can involve the controller 50 identifying whether the integrated flow control valve 30 is being controlled in a flow stop state. That is, the controller 50 can close the integrated flow control valve 30, preventing the coolant from circulating from the engine 10 to the ATF warmer 23, the heater 24, and the radiator 26, while the coolant remains inside the engine 10, thereby accelerating the warm-up of the engine 10.

However, a portion of the coolant can circulate through the engine 10 and the EGR cooler 22.

The flow stop releasing step (S225)(S235) can involve the controller 50 releasing the flow stop control of the integrated flow control valve 30.

The controller 50 can release the flow stop control of the integrated flow control valve 30, allowing a portion of the coolant to flow into the exhaust heat recovery system 25.

The water temperature condition comparison step (S226)(S236) can involve the controller 50 identifying whether the temperature of the coolant discharged from the exhaust heat recovery system 25 is below the recovery entry temperature, which can be preset to trigger entry into exhaust heat recovery control in the exhaust heat recovery system 25, while the temperature of the coolant discharged from the exhaust heat recovery system 25 exceeds the temperature of the coolant discharged from the engine 10.

The water temperature condition comparison step (S226)(S236) can be performed to identify whether the heat from the exhaust heat recovery system 25 may be absorbed by the engine 10 by allowing the coolant to flow from the engine 10 to the exhaust heat recovery system 25 through the flow stop releasing step (S225)(S235).

That is, when the engine 10 is not sufficiently warmed up, the coolant can absorb the heat from the exhaust gas through the exhaust heat recovery system 25 and transfer the heat to the engine 10, thereby accelerating the warm-up of the engine 10.

However, when the coolant temperature in the exhaust heat recovery system 25 is equal to or higher than the recovery entry temperature, the coolant can be in a state overheated or approaching overheating. In this case, the coolant circulating through the engine 10 and the exhaust heat recovery system 25 can then dissipate heat to the atmosphere.

Therefore, through the water temperature condition comparison step (S226)(S236), the controller can compare the temperature of the coolant discharged from the exhaust heat recovery system 25 with the temperature of the coolant discharged from the engine 10, and identify whether the temperature of the coolant discharged from the exhaust heat recovery system 25 is below the recovery entry temperature.

The recovery entry temperature may be set to 100° C. That is, the condition for recovering the heat from the exhaust gas to the engine 10 from the exhaust heat recovery system 25 can be limited to when the temperature of the coolant discharged from the exhaust heat recovery system 25 is equal to or below its boiling point.

The exhaust heat recovery entry step (S227)(S237) can involve the controller 50 controlling the exhaust heat recovery system 25 to recover exhaust heat.

The exhaust heat recovery entry step (S227)(S237) can involve the controller 50 controlling the drive motor 25c, which can be provided in the exhaust heat recovery system 25, to ensure that the exhaust gas passing through the exhaust heat recovery system 25 exchanges heat with the coolant passing through the exhaust heat recovery system 25.

The exhaust heat recovery system 25 can be equipped with a bypass valve that determines the flow direction of the exhaust gas. The bypass valve can be operated by the drive motor 25c, which can be provided on one side of the exhaust heat recovery system 25.

In the exhaust heat recovery entry step (S227)(S237), the controller 50 can operate the drive motor 25c to ensure that the exhaust gas exchanges heat with the coolant and is discharged, as controlled by the bypass valve.

As a result, the coolant can absorb the heat from the exhaust gas in the exhaust heat recovery system 25. Because the coolant can circulate through the engine 10 and the exhaust heat recovery system 25, the heat absorbed from the exhaust heat recovery system 25 can be transferred to the engine 10, thereby accelerating the warm-up of the engine 10.

In a method of controlling coolant of a vehicle according to this example embodiment, based on the temperature of the outside air in the second outside air temperature comparison step (S210), the mode entry step (S221)(S231) to the exhaust heat recovery entry step (S227)(S237) can be performed as follows.

The second outside air temperature comparison step (S210) can involve the controller 50 identifying whether the temperature of the outside air exceeds the preset low-temperature reference temperature (TA_L) or is below or equal to the low-temperature reference temperature (TA_L) to identify the temperature of the outside air as low temperature.

In this example embodiment, the temperature of the outside air can be classified into room and low temperatures for different control actions. The controller 50 can identify whether the temperature of the outside air exceeds or is below or equal to the low-temperature reference temperature (TA_L), which serves as a reference.

First, when the temperature of the outside air exceeds the low-temperature reference temperature (TA_L), the controller 50 can control as follows.

When the temperature of the outside air exceeds the low-temperature reference temperature (TA_L), the mode entry step (S221)(S231) can be performed as a room-temperature mode entry step (S221), which can start to control the exhaust heat recovery system 25 and the integrated flow control valve 30 in a room temperature mode.

The room-temperature mode entry step (S221) can involve the controller 50 controlling the coolant to circulate between the ATF warmer 23 and the exhaust heat recovery system 25.

The bypass identification step (S222)(S232) can involve the controller 50 performing a first bypass identification step (S222) to identify the state of the exhaust heat recovery system 25. That is, the first bypass identification step (S222) can identify whether the exhaust gas bypasses and directly passes through the exhaust heat recovery system 25 without exchanging heat with the coolant in the room temperature mode.

In a room temperature environment, the flow stop identification step (S223)(S233) can be performed as a first flow stop step (S223), where the controller 50 can identify whether the integrated flow control valve 30 is being controlled in a flow stop state in the room temperature mode.

Through the first bypass identification step (S222) and the first flow stop identification step (S223), the controller 50 can identify whether, in a room temperature environment, the temperature of the coolant in the exhaust heat recovery system 25 can be in a temperature rising condition due to the exhaust gas continuing to flow through the exhaust heat recovery system 25 while the coolant does not circulate.

When the exhaust gas and the coolant are in a heat exchange state in the first bypass identification step (S222), the process can return to the room-temperature mode entry step (S221). When the integrated flow control valve 30 is not being controlled in a flow stop state in the first flow stop identification step (S223), the controller 50 can maintain the current state and continue to control the integrated flow control valve 30 accordingly (S224).

In the first flow stop identification step (S223), when the controller 50 identifies that the integrated flow control valve 30 is being controlled in a flow stop state, the controller 50 can perform a first flow stop releasing step (S225) to release the flow stop control of the integrated flow control valve 30 in the room temperature mode.

The first flow stop releasing step (S225) can involve the controller 50 controlling the coolant to flow from the engine 10 to the exhaust heat recovery system 25 through the integrated flow control valve 30. For example, the flow stop may be released by allowing the coolant to flow from the integrated flow control valve 30 to the ATF warmer 23.

As a result, when the flow stop is released, the coolant can circulate through the engine 10 and the exhaust heat recovery system 25, allowing heat transfer from the exhaust heat recovery system 25 to the engine 10.

In a room temperature environment, the water temperature condition comparison step (S226)(S236) can be performed as a first water temperature condition comparison step (S226) in which the controller 50 identifies whether the temperature of the coolant discharged from the exhaust heat recovery system 25 is below the recovery entry temperature, which is preset to trigger entry into exhaust heat recovery control in the exhaust heat recovery system 25, while the temperature of the coolant discharged from the exhaust heat recovery system 25 exceeds the temperature of the coolant discharged from the engine 10.

Through the first flow stop releasing step (S225), after heat transfer to the exhaust heat recovery system 25, the first water temperature condition comparison step (S226) can be performed to identify whether additional heat transfer from the exhaust heat recovery system 25 to the engine 10 is possible.

If the temperature of the coolant discharged from the exhaust heat recovery system 25 exceeds the temperature of the coolant discharged from the engine 10, the engine 10 can be in a state of being able to absorb additional heat from the exhaust heat recovery system 25. In particular, because the temperature of the coolant on the exhaust heat recovery system 25 side is below the recovery entry temperature, even if heat transfer occurs from the exhaust heat recovery system 25 to the engine 10, a stable state may be maintained. The recovery entry temperature may be set to 100° C. Because the coolant temperature on the exhaust heat recovery system 25 side exceeds the coolant temperature of the engine 10 but is still below the boiling point, the coolant discharged from the exhaust heat recovery system 25 does not dissipate heat to the outside for cooling. Instead, the heat is transferred to the engine 10.

When the conditions of the first water temperature condition comparison step (S226) are met, the first exhaust heat recovery entry step (S227) can be performed, where the controller 50 can start to control the exhaust heat recovery system 25 in a state in which heat exchange is possible in a room temperature environment. The controller 50 can operate the drive motor 25c to ensure that the exhaust gas passes through the coolant side in the exhaust heat recovery system 25 and is discharged to the outside, thereby transferring the heat from the exhaust heat recovery system 25 to the engine 10.

When the conditions of the first water temperature condition comparison step (S226) are not met, the controller 50 can continue to control the integrated flow control valve 30 in its current state (S228).

Further, when the temperature of the outside air is below the low-temperature reference temperature (TA_L), the control can be as follows.

When the temperature of the outside air is below the low-temperature reference temperature (TA_L), the mode entry step (S221)(S231) can be performed as a low-temperature mode entry step (S231), which can start to control the exhaust heat recovery system 25 and the integrated flow control valve 30 in a low-temperature mode.

The low-temperature mode entry step (S231) can involve the controller 50 controlling the coolant to circulate between the heater 24 and the exhaust heat recovery system 25.

In a low-temperature environment, the bypass identification step (S222) (S232) can be performed as a second bypass identification step (S232), where the controller 50 can identify the state of the exhaust heat recovery system 25. That is, the second bypass identification step (S232) can identify whether, in low-temperature mode, the exhaust gas bypasses the coolant without exchanging heat and passes directly through the exhaust heat recovery system 25, resulting in no heat exchange.

In a low-temperature environment, the flow stop identification step (S223)(S233) can be performed as a second flow stop step (S233), where the controller 50 can identify whether the integrated flow control valve 30 is being controlled in a flow stop state in room temperature mode.

In this example embodiment, through the second bypass identification step (S232) and the second flow stop identification step (S233), the controller 50 may identify whether, in a low-temperature environment, the temperature of the coolant in the exhaust heat recovery system 25 is in a continuous rising temperature condition due to the exhaust gas continuing to flow through the exhaust heat recovery system 25 while the coolant does not circulate.

When the conditions of the second bypass identification step (S232) and the second flow stop identification step (S233) are not met, the process can return to the low-temperature mode entry step (S231), as in the second bypass identification step (S232) and the second flow stop identification step (S233), and the integrated flow control valve 30 is controlled in its current state (S234).

However, in the second flow stop identification step (S233), when the controller 50 identifies that the integrated flow control valve 30 is being controlled in a flow stop state, the controller 50 can perform a second flow stop releasing step (S235) to release the flow stop control of the integrated flow control valve 30 in low-temperature mode.

The second flow stop releasing step (S235), like the first flow stop releasing step (S225), can involve the controller 50 controlling the coolant to flow from the engine 10 to the exhaust heat recovery system 25 through the integrated flow control valve 30. However, because the temperature of the outside air is equal to or below the low-temperature reference temperature (TA_L), the flow stop may be released by allowing the coolant to flow from the integrated flow control valve 30 to the heater 24.

As a result, once the flow stop is released, the coolant can circulate through the engine 10 and the exhaust heat recovery system 25.

In a low-temperature environment, the water temperature condition comparison step (S226)(S236) can be performed as a second water temperature condition comparison step (S236). The second water temperature condition comparison step (S236) may be performed in the same manner as the first water temperature condition comparison step (S226). That is, the controller 50 can identify whether the temperature of the coolant discharged from the exhaust heat recovery system 25 is below the recovery entry temperature, which can be preset to trigger entry into exhaust heat recovery control in the exhaust heat recovery system 25, while the temperature of the coolant discharged from the exhaust heat recovery system 25 exceeds the temperature of the coolant discharged from the engine 10. In the second water temperature condition comparison step (S236), the recovery entry temperature may be set to the same temperature as in the first water temperature condition comparison step (S226).

The second water temperature condition comparison step (S236) can be also performed to identify whether the engine 10 may receive additional heat transfer from the exhaust heat recovery system 25.

When the conditions of the second water temperature condition comparison step (S236) are met, a second exhaust heat recovery entry step (S237) can be performed, where the controller 50 can start to control the exhaust heat recovery system 25 in a state in which heat exchange is possible in a low-temperature environment. The controller 50 can operate the drive motor 25c to ensure that the exhaust gas passes through the coolant side in the exhaust heat recovery system 25 and is discharged to the outside, thereby enabling heat transfer from the exhaust heat recovery system 25 to the engine 10.

When the conditions of the second water temperature condition comparison step (S236) are not met, the controller 50 can continue to control the integrated flow control valve 30 in its current state (S238).

What is claimed is:

1. A system for controlling coolant of a vehicle, comprising:
an integrated flow control valve configured to open and close branch lines to supply coolant discharged from an engine of the vehicle to an automatic transmission fluid (ATF) warmer, a heater, and a radiator, respectively;
an exhaust heat recovery system configured to exchange heat between exhaust gas discharged from the engine and the coolant discharged from the engine;
a main water pump configured to circulate the coolant;
return lines configured to circulate the coolant from the exhaust heat recovery system to the ATF warmer and the heater, respectively; and
a controller configured to:
control the integrated flow control valve to open and close the branch lines to supply coolant from the integrated flow control valve to the ATF warmer, the heater, and the radiator, respectively, depending on an outside-air temperature of outside air, an engine coolant temperature for the coolant discharged from the engine, and an exhaust-heat-recovery-system coolant temperature for the coolant discharged from the exhaust heat recovery system,
control the exhaust heat recovery system to allow heat exchange between the exhaust gas and the coolant,
and
control circulation of the coolant to either the ATF warmer or the heater from the exhaust heat recovery system based on the outside-air temperature of the outside air.

2. The system of claim 1, wherein the exhaust heat recovery system includes a drive motor configured to operate the exhaust heat recovery system to either exchange heat between the exhaust gas and the coolant or allow the exhaust gas to pass through the exhaust heat recovery system with reduced or no exchanging heat with the coolant, and
wherein the controller is configured to control the drive motor.

3. The system of claim 2, wherein the controller is configured to determine whether the outside-air temperature of the outside air is equal to or higher than a high-temperature reference temperature to determine that the outside-air temperature of the outside air as a high temperature, equal to or lower than a low-temperature reference temperature to determine the outside-air temperature of the outside air as a low temperature, wherein the low-temperature reference temperature is lower than the high-temperature reference temperature, or lower than the high-temperature reference temperature and above the low-temperature reference temperature to determine that the outside-air temperature of the outside air as a room temperature,
wherein based on the outside-air temperature of the outside air exceeding the low-temperature reference temperature, the controller is configured to control the drive motor to allow the exhaust gas and the coolant to flow and exchange heat in the exhaust heat recovery system, circulating the coolant between the exhaust heat recovery system and the ATF warmer, and
wherein based on the outside-air temperature of the outside air being equal to or below the low-temperature reference temperature, the controller is configured to control the drive motor to allow the exhaust gas and the coolant to flow and exchange heat in the exhaust heat recovery system, circulating the coolant between the exhaust heat recovery system and the heater.

4. The system of claim 3, wherein the controller is configured to control the drive motor to allow the exhaust gas to flow through the exhaust heat recovery system with reduced or no exchanging heat with the coolant, based on the exhaust-heat-recovery-system coolant temperature of the coolant discharged from the exhaust heat recovery system exceeding a bypass reference temperature.

5. The system of claim 2, wherein the controller is configured to determine whether the outside-air temperature of the outside air is above a low-temperature reference temperature to determine the outside-air temperature of the outside air as a low temperature, or equal to or below the low-temperature reference temperature, and
wherein the controller is configured to control the integrated flow control valve to allow the coolant discharged from the engine to flow to the ATF warmer, based on the outside-air temperature of the outside air exceeding the low-temperature reference temperature, and control the integrated flow control valve to allow the coolant discharged from the engine to flow to the heater, based on the outside-air temperature of the outside air being equal to or below the low-temperature reference temperature.

6. The system of claim 5, wherein the controller is configured to control the coolant to flow from the engine to the exhaust heat recovery system through the integrated flow control valve, based on the exhaust gas in the exhaust heat recovery system flowing with reduced or no exchanging heat with the coolant and the coolant being not discharged from the integrated flow control valve.

7. The system of claim 6, wherein the controller is configured to control the drive motor to allow the exhaust gas and the coolant to exchange heat and flow in the exhaust heat recovery system, based on the exhaust-heat-recovery-system coolant temperature of the coolant discharged from the exhaust heat recovery system exceeding the engine coolant temperature of the coolant discharged from the engine, and the exhaust-heat-recovery-system coolant temperature of the coolant discharged from the exhaust heat recovery system being below a recovery entry temperature.

8. A method of controlling coolant of a vehicle, comprising:
as a first outside air temperature comparison step, comparing an outside-air temperature of an outside air with a reference temperature to determine where to circulate coolant discharged from an engine between an automatic transmission fluid (ATF) warmer and a heater, and to determine when to stop heat exchange between the coolant and an exhaust heat recovery system;
as a circulation step, based on the outside-air temperature of the outside air, supplying the coolant discharged from the exhaust heat recovery system to either the ATF warmer or the heater;
as an exhaust heat recovery step, supplying the coolant discharged from the engine to the exhaust heat recovery system;
as a water temperature comparison step, determining whether an exhaust-heat-recovery-system coolant temperature of the coolant discharged from the exhaust heat recovery system exceeds a bypass temperature to allow the coolant to bypass the exhaust heat recovery system; and
as a bypass step, based on the exhaust-heat-recovery-system coolant temperature of the coolant discharged from the exhaust heat recovery system exceeding the bypass temperature, allowing exhaust gas to flow through the exhaust heat recovery system such that the exhaust gas has reduced or no heat exchange with the coolant.

9. The method of claim 8, wherein the first outside air temperature comparison step includes determining whether the outside-air temperature of the outside air is equal to or higher than a high-temperature reference temperature that is set to determine the outside-air temperature of the outside air as a high temperature, equal to or lower than a low-temperature reference temperature that is set to determine the outside-air temperature of the outside air as a low temperature and be lower than the high-temperature reference temperature, or lower than the high-temperature reference temperature and above the low-temperature reference temperature to determine the outside-air temperature of the outside air as a room temperature.

10. The method of claim 9, wherein in the first outside air temperature comparison step, based on the outside-air temperature of the outside air being equal to or higher than the high-temperature reference temperature:
the circulation step is performed as a first circulation step including flowing the coolant from the exhaust heat recovery system to the ATF warmer;
the exhaust heat recovery step is performed as a first exhaust heat recovery step including discharging the coolant from the engine is introduced into the exhaust heat recovery system;
the water temperature comparison step is performed as a first water temperature comparison step including determining whether the exhaust-heat-recovery-system coolant temperature of the coolant discharged from the exhaust heat recovery system exceeds a high-temperature bypass temperature, which is set to bypass the exhaust heat recovery system in case of a high temperature; and
a first bypass step is performed including allowing the coolant to bypass the exhaust heat recovery system, based on the exhaust-heat-recovery-system coolant temperature of the coolant exceeding the high-temperature bypass temperature.

11. The method of claim 9, wherein in the first outside air temperature comparison step, based on the outside-air temperature of the outside air being a room temperature that is below the high-temperature reference temperature and above the low-temperature reference temperature:
the circulation step is performed as a second circulation step including flowing the coolant from the exhaust heat recovery system to the ATF warmer;
the exhaust heat recovery step is performed as a second exhaust heat recovery step including discharging the coolant from the engine to be introduced into the exhaust heat recovery system;
the water temperature comparison step is performed as a second water temperature comparison step including determining whether the exhaust-heat-recovery-system coolant temperature of the coolant discharged from the exhaust heat recovery system exceeds a room-temperature bypass temperature, which is set to bypass the exhaust heat recovery system in case of a room temperature; and
a second bypass step is performed including allowing the coolant to bypass the exhaust heat recovery system, based on the exhaust-heat-recovery-system coolant temperature of the coolant exceeding the room-temperature bypass temperature.

12. The method of claim 9, wherein in the first outside air temperature comparison step, based on the outside-air temperature of the outside air being equal to or lower than the low-temperature reference temperature:
the circulation step is performed as a third circulation step including flowing the coolant from the exhaust heat recovery system to the heater;
the exhaust heat recovery step is performed as a third exhaust heat recovery step including discharging the coolant from the engine to be introduced into the exhaust heat recovery system;
the water temperature comparison step is performed as a third water temperature comparison step including determining whether the exhaust-heat-recovery-system coolant temperature of the coolant discharged from the exhaust heat recovery system exceeds a low-temperature bypass temperature, which is set to bypass the exhaust heat recovery system in case of a low temperature; and
a third bypass step is performed including allowing the coolant to bypass the exhaust heat recovery system, based on the exhaust-heat-recovery-system coolant temperature of the coolant exceeding the low-temperature bypass temperature.

13. The method of claim 9, wherein the bypass temperature is set to be lower as the outside-air temperature of the outside air increases.

14. The method of claim 13, wherein the bypass temperature is set to:
a high-temperature bypass temperature, based on the outside-air temperature of the outside air being equal to or higher than the high-temperature reference temperature;
a low-temperature bypass temperature, based on the outside-air temperature of the outside air being equal to or lower than the low-temperature reference temperature; and
a room-temperature bypass temperature, based on the outside-air temperature of the outside air being below the high-temperature reference temperature but above the low-temperature reference temperature,
wherein the room-temperature bypass temperature is set to be higher than the high-temperature bypass temperature, and the low-temperature bypass temperature is set to be higher than the room-temperature bypass temperature.

15. A method of controlling coolant of a vehicle, comprising:
as a second outside air temperature comparison step, comparing an outside-air temperature of an outside air with a reference temperature to determine an operating mode of an exhaust heat recovery system and an integrated flow control valve;
as a mode entry step, based on the outside-air temperature of the outside air, causing the integrated flow control valve to enter a first operating mode;
as a bypass determination step, determining whether exhaust gas passes through the exhaust heat recovery system with reduced or no exchanging heat with the coolant;
as a flow stop determination step, determining whether the integrated flow control valve is controlled in a flow stop state;
as a flow stop releasing step, releasing a flow stop control of the integrated flow control valve;
as a water temperature condition comparison step, determining whether an exhaust-heat-recovery-system coolant temperature of the coolant discharged from the exhaust heat recovery system is below a recovery entry temperature, which is preset to trigger entry into exhaust heat recovery control in the exhaust heat recovery system, while the exhaust-heat-recovery-system coolant temperature of the coolant discharged from the exhaust heat recovery system exceeds an engine coolant temperature of the coolant discharged from an engine; and
as an exhaust heat recovery entry step, controlling the exhaust heat recovery system to recover exhaust heat.

16. The method of claim 15, wherein the exhaust heat recovery entry step includes controlling a drive motor provided in the exhaust heat recovery system, such that the exhaust gas passing through the exhaust heat recovery system exchanges heat with the coolant passing through the exhaust heat recovery system.

17. The method of claim 15, wherein the second outside air temperature comparison step includes determining whether the outside-air temperature of the outside air exceeds a low-temperature reference temperature that is preset to determine the outside-air temperature of the outside air as a low temperature, or equal to or below the low-temperature reference temperature.

18. The method of claim 17, wherein in the second outside air temperature comparison step, based on the outside-air temperature of the outside air exceeding the low-temperature reference temperature:
the mode entry step is performed as a room-temperature mode entry step including starting to control the exhaust heat recovery system and the integrated flow control valve in a room temperature mode;
the bypass determination step is performed as a first bypass determination step including determining whether the exhaust gas passes through the exhaust heat recovery system with reduced or no exchanging heat with the coolant in the room temperature mode;
the flow stop determination step is performed as a first flow stop determination step including determining whether the integrated flow control valve is being controlled in a flow stop state in the room temperature mode;
the flow stop releasing step is performed as a first flow stop releasing step including releasing a flow stop control of the integrated flow control valve in the room temperature mode;
the water temperature condition comparison step is performed as a first water temperature condition comparison step including determining whether the exhaust-heat-recovery-system coolant temperature of the coolant discharged from the exhaust heat recovery system is below a recovery entry temperature, which is preset to trigger entry into exhaust heat recovery control in the exhaust heat recovery system, while the exhaust-heat-recovery-system coolant temperature of the coolant discharged from the exhaust heat recovery system exceeds an engine coolant temperature of the coolant discharged from the engine in the room temperature mode; and
the exhaust heat recovery entry step is performed as a first exhaust heat recovery entry step including controlling a drive motor provided in the exhaust heat recovery system to allow the exhaust gas to exchange heat with the coolant in the exhaust heat recovery system.

19. The method of claim 17, wherein in the second outside air temperature comparison step, based on the outside-air temperature of the outside air does not exceeding the low-temperature reference temperature:
the mode entry step is performed as a low-temperature mode entry step including starting to control the exhaust heat recovery system and the integrated flow control valve in a low temperature mode;
the bypass determination step is performed as a second bypass determination step including determining whether the exhaust gas passes through the exhaust heat recovery system with reduced or no exchanging heat with the coolant in the low temperature mode;
the flow stop determination step is performed as a second flow stop determination step including determining whether the integrated flow control valve is being controlled in a flow stop state in the low temperature mode;
the flow stop releasing step is performed as a second flow stop releasing step including releasing a flow stop control of the integrated flow control valve in the low temperature mode;
the water temperature condition comparison step is performed as a second water temperature condition comparison step including determining whether the exhaust-heat-recovery-system coolant temperature of the coolant discharged from the exhaust heat recovery system is below a recovery entry temperature, which is preset to trigger entry into exhaust heat recovery control in the exhaust heat recovery system, while the exhaust-heat-recovery-system coolant temperature of the coolant discharged from the exhaust heat recovery system exceeds an engine coolant temperature of the coolant discharged from the engine in the low temperature mode; and
the exhaust heat recovery entry step is performed as a second exhaust heat recovery entry step including controlling a drive motor provided in the exhaust heat recovery system to allow the exhaust gas to exchange heat with the coolant in the exhaust heat recovery system.
